(19) United States
(12) Patent Application Publication
(10) Pub. No.: US 2023/0333439 A1
(43) Pub. Date: Oct. 19, 2023

(54) OPTICAL MODULATOR, PHASE SHIFTER, AND OPTICAL COMMUNICATION APPARATUS

(71) Applicant: Fujitsu Optical Components Limited, Kawasaki-shi (JP)

(72) Inventor: Masaki SUGIYAMA, Kawasaki (JP)

(73) Assignee: Fujitsu Optical Components Limited, Kawasaki-shi (JP)

(21) Appl. No.: 18/165,039

(22) Filed: Feb. 6, 2023

(30) Foreign Application Priority Data
Apr. 13, 2022 (JP) 2022-066337

(51) Int. Cl. G02F 1/225; G02F 1/21; G02F 1/01; H04J 14/06

(52) U.S. Cl. CPC G02F 1/2252; G02F 1/212; G02F 1/0121; H04J 14/06; G02F 2201/12; G02F 2201/17; G02F 2203/50

(57) ABSTRACT

An optical modulator includes a first shifter and a second shifter. The first shifter includes a first waveguide through which first light passes, and a first electrode that causes power according to a drive voltage to act on the first waveguide. The first shifter shifts a phase of the first light passing through the first waveguide in accordance with the drive voltage applied to the first electrode. The second shifter includes a second waveguide through which second light passes, and a second electrode that causes power according to a drive voltage to act on the second waveguide. The second shifter shifts a phase of the second light passing through the second waveguide in accordance with the drive voltage applied to the second electrode. The second shifter is constituted to have a smaller amount of phase shift according to a predetermined amount of drive voltage than the first shifter.

### CROSS-REFERENCE TO RELATED APPLICATION

This application is based upon and claims the benefit of priority of the prior Japanese Patent Application No. 2022-066337, filed on Apr. 13, 2022, the entire contents of which are incorporated herein by reference.

### FIELD

The embodiments discussed herein are related to an optical modulator, a phase shifter, and an optical communication apparatus.

### BACKGROUND

In an optical modulator, four-channel Mach-Zehnder modulators are integrated. Each of Mach-Zehnder interferometers (MZI) includes a radio frequency phase shifter (RFPS) and a direct current phase shifter (DCPS). The RFPS is an MZI that receives an input of a high-speed signal having a band of, for example, several tens of gigahertz (GHz) and that performs high-speed modulation. The DCPS is an MZI that is constituted of, for example, a heater electrode, that causes a refractive index of an optical waveguide to be changed by heating an optical waveguide as a result of causing an electric current to flow through the heater electrode, and that adjusts a phase of light. The optical modulator adjusts electric current flowing through the heater electrode of the DCPS such that ON/OFF of an electrical signal input to the RFPS is associated with ON/OFF of an optical signal.

The optical modulator includes a DC side MZM that adjusts a phase of signal light. FIG. 12 is a schematic plan view illustrating an example of a configuration of a DC side MZM 200. The DC side MZM 200 illustrated in FIG. 12 includes a DCPS 210, a multiplexing portion 220, and a clad layer 230. The DCPS 210 includes a first DCPS 210A that shifts a phase of first signal light, and a second DCPS 210B that shifts a phase of second signal light. The first signal light and the second signal light are pieces of signal light that are branched off from, for example, input light.

The first DCPS 210A includes a first optical waveguide 211A that is provided on a Si substrate and through which the first signal light passes, and a first DC electrode 212A that is disposed parallel to the first optical waveguide 211A and that heats the first optical waveguide 211A by electric power according to a drive voltage. The first DC electrode 212A is a heater electrode constituted of, for example, a metal material, such as Ti, having a resistance property. The first DCPS 210A heats the first optical waveguide 211A by electric power according to a drive voltage and causes an optical refractive index of the first optical waveguide 211A to be changed by the thermo-optical effect of Si. The first DCPS 210A shifts the phase of the first signal light passing through the first optical waveguide 211A by causing the optical refractive index of the first optical waveguide 211A to be changed, and outputs the first signal light that is obtained after a phase shift has been performed to the multiplexing portion 220.

The second DCPS 210B includes a second optical waveguide 211B that is provided on a Si substrate and through which the second signal light passes, and a second DC electrode 212B that is disposed parallel to the second optical waveguide 211B and that heats the second optical waveguide 211B by electric power according to a drive voltage. The second DC electrode 212B is a heater electrode constituted of, for example, a metal material, such as Ti, having a resistance property. The second DCPS 210B heats the second optical waveguide 211B by electric power according to a drive voltage and causes an optical refractive index of the second optical waveguide 211B to be changed by the thermo-optical effect of Si. The second DCPS 210B shifts the phase of the second signal light passing through the second optical waveguide 211B by causing the optical refractive index of the second optical waveguide 211B to be changed, and outputs the second signal light that is obtained after a phase shift has been performed to the multiplexing portion 220.

The multiplexing portion 220 multiplexes the first signal light that is obtained after the phase shift has been performed and the second signal light that is obtained after the phase shift has been performed. A clad layer 230 is a layer that is made of, for example, SiO₂ and that covers the first DCPS 210A, the second DCPS 210B, and the multiplexing portion 220. That is, the DC side MZM 200 multiplexes the first signal light that is obtained after the phase shift has been performed in the first DCPS 210A and the second signal light that is obtained after the phase shift has been performed in the second DCPS 210B, and outputs signal light whose phase has been adjusted.
Patent Document 1: Japanese Laid-open Patent Publication No. 2016-133664
Patent Document 2: U.S. Patent Application Publication No. 2017/0099529
Patent Document 3: Japanese Laid-open Patent Publication No. 2019-191252

However, there is a need to compensate, over a long period of time, instability of the phase generated due to a variation in parts, such as a RFPS, caused by a state below the maximum voltage of the drive voltage applied to the DCPS limited by an electric power source.

FIG. 13A is a diagram illustrating an example of a relationship between a drive voltage and output light in the DCPS 210 included in the DC side MZM 200 that is conventionally used. In the case where the maximum voltage applied to the DCPS 210 is defined as 5 V, an amount of phase shift that is needed to compensate a phase instability is defined as 4 π, the relationship between the drive voltage applied to the heater electrode and the output light (transmittance) is as illustrated in FIG. 13A.

FIG. 13B is a diagram illustrating an example of an inclination (amount of change) relative to a drive voltage in the DCPS 210 included in the conventional DC side MZM 200. The relationship of an amount of change between the drive voltage applied to the heater electrode and the output light indicates that, as illustrated in FIG. 13B, an inclination (amount of change) of the output light relative to the drive voltage is increased. In particular, in a case where the output light is made to be decreased, the inclination (amount of change) of the output light relative to the drive voltage is increased. For example, when the output light is adjusted to −15 dB, the inclination (amount of change) at that time is 55 dB/V, which is increased. Therefore, there is a need to control the drive voltage with high accuracy, but it is difficult to perform drive control with high accuracy. Consequently, it is difficult to make a fine adjustment of the output light while ensuring the amount of phase shift in the DCPS.

### SUMMARY

According to an aspect of an embodiment, an optical modulator includes a first phase shifter and a second phase shifter. The first phase shifter includes a first optical waveguide through which first signal light passes, and a first direct current electrode that is disposed parallel to the first optical waveguide and that causes electric power according to a drive voltage to act on the first optical waveguide. The first phase shifter shifts a phase of the first signal light passing through the first optical waveguide in accordance with the drive voltage applied to the first direct current electrode. The second phase shifter includes a second optical waveguide through which second signal light passes, and a second direct current electrode that is disposed parallel to the second optical waveguide and that causes electric power according to a drive voltage to act on the second optical waveguide. The second phase shifter shifts a phase of the second signal light passing through the second optical waveguide in accordance with the drive voltage applied to the second direct current electrode. The second phase shifter is constituted to have a smaller amount of phase shift according to a predetermined amount of drive voltage than the first phase shifter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to a present embodiment;

FIG. 2 is a schematic plan view illustrating an example of a configuration of an optical modulator;

FIG. 3 is a schematic plan view illustrating an example of a configuration of a DC side child MZM according to a first embodiment;

FIG. 4A is a diagram illustrating an example of a relationship between a drive voltage and output light in a first DCPS and a second DCPS included in the DC side child MZM;

FIG. 4B is a diagram illustrating an example of a relationship of an inclination (amount of change) relative to a drive voltage in the first DCPS and the second DCPS included in the DC side child MZM;

FIG. 5 is a schematic plan view illustrating an example of a configuration of a DC side child MZM according to a second embodiment;

FIG. 6 is a schematic plan view illustrating an example of a configuration of a DC side child MZM according to a third embodiment;

FIG. 7 is a schematic plan view illustrating an example of a configuration of a DC side child MZM according to a fourth embodiment;

FIG. 8 is a schematic plan view illustrating an example of a configuration of a DC side child MZM according to a fifth embodiment;

FIG. 9 is a schematic plan view illustrating an example of a configuration of a DC side child MZM according to a sixth embodiment;

FIG. 10 is a schematic plan view illustrating an example of a configuration of a DC side child MZM according to a seventh embodiment;

FIG. 11 is a schematic plan view illustrating an example of a configuration of a DC side child MZM according to an eighth embodiment;

FIG. 12 is a schematic plan view illustrating an example of a configuration of a conventional DC side MZM;

FIG. 13A is a diagram illustrating an example of a relationship between a drive voltage output light in a DCPS included in the conventional DC side MZM; and

FIG. 13B is a diagram illustrating an example of an inclination (amount of change) relative to a drive voltage in the DCPS included in the conventional DC side MZM.

### DESCRIPTION OF EMBODIMENTS

Preferred embodiments of the present invention will be explained with reference to accompanying drawings. Furthermore, the present invention is not limited to the embodiments.

### (a) First Embodiment

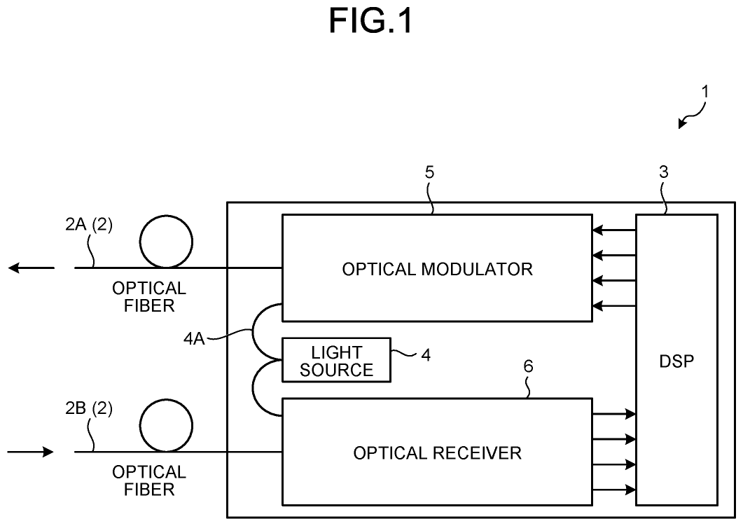

FIG. 1 is a block diagram illustrating an example of a configuration of an optical communication apparatus according to the present embodiment. An optical communication apparatus 1 illustrated in FIG. 1 is, for example, an optical coherent transmitter/receiver that is connected to an optical fiber 2A (2) that is disposed on the output side and an optical fiber 2B (2) that is disposed on the input side. The optical communication apparatus 1 includes a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, and outputs a data signal corresponding to the processed transmission data to the optical modulator 5. Furthermore, the DSP 3 performs a process of, for example, decoding the reception data that has been obtained from the optical receiver 6 and that corresponds to the data signal.

The light source 4 is, for example, an integrated tunable laser assembly (ITLA) that includes, for example, a wavelength-tunable laser diode or the like, that emits light at a predetermined wavelength, and that supplies the light to the optical modulator 5 through an optical fiber 4A and the optical receiver 6.

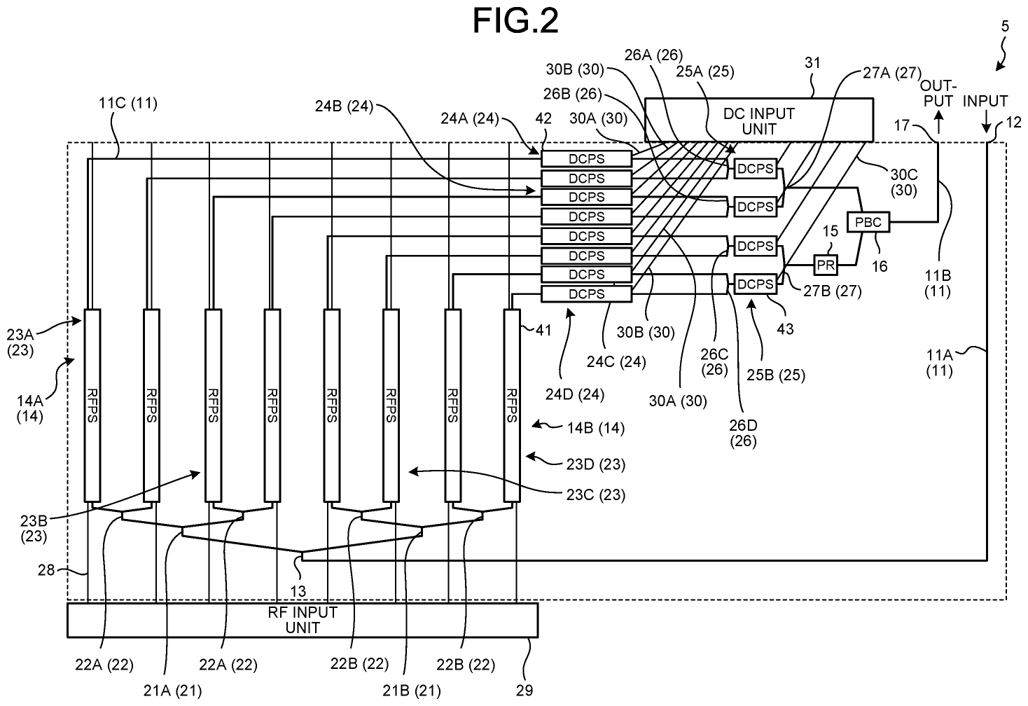

FIG. 2 is a schematic plan view illustrating an example of a configuration of the optical modulator 5. The optical modulator 5 illustrated in FIG. 2 includes an optical waveguide 11, an optical input portion 12, a first branching portion 13, an X polarization MZM 14A (14), and a Y polarization MZM 14B (14). The optical modulator 5 includes a polarization rotator (PR) 15, a polarization beam combiner (PBC) 16, an optical output portion 17, a DC input unit 31 and an RF input unit 29.

The optical waveguide 11 is a Si waveguide that includes an optical waveguide 11A, an optical waveguide 11B, and an optical waveguide 11C. The optical waveguide 11A is an optical waveguide that connects a portion between the optical input portion 12 and the first branching portion 13. The optical waveguide 11B is an optical waveguide that connects a portion between a second multiplexing portion 27A (27) and the optical output portion 17 included in the X polarization MZM 14A and a portion between a second multiplexing portion 27B (27) and the optical output portion 17 included in the Y polarization MZM 14B. The optical waveguide 11C is an optical waveguide that connects a portion between the first branching portion 13 and the second multiplexing portion 27.

The optical input portion 12 inputs laser light received from the light source 4. The first branching portion 13 optically branches the laser light received from the optical input portion 12, and outputs the optically branched laser light to the X polarization MZM 14A and the Y polarization MZM 14B.

The X polarization MZM 14A performs quadrature phase modulation, by using an X polarization data signal, the laser light that has been branched off at the first branching portion 13, and outputs the signal light having an X polarization IQ component to the PBC 16. The Y polarization MZM 14B performs quadrature phase modulation on the laser light that has been branched off at the first branching portion 13 by using a Y polarization data signal, and outputs the signal light having a Y polarization IQ component to the PR 15. The PR 15 performs polarization rotation on the signal light that has the Y polarization IQ component received from the Y polarization MZM 14B, converts the signal light to signal light having the X polarization IQ component, and outputs the converted signal light having the X polarization IQ component to the PBC 16. Furthermore, the PBC 16 multiplexes the signal light having the X polarization IQ component received from the X polarization MZM 14A and the converted signal light having the X polarization IQ component received from the PR 15, and outputs polarization division multiplexing signal light to the optical output portion 17.

The X polarization MZM 14A includes a second branching portion 21A (21), two pieces of third branching portions 22 (22A), two RF side MZMs 23 (23A, 23B), two DC side child MZMs 24 (24A, 24B), and two first multiplexing portion 26 (26A, 26B). Furthermore, the X polarization MZM 14A includes a DC side parent MZM 25 (25A) and the second multiplexing portion 27 (27A).

The third branching portion 22A branches off the laser light received from the second branching portion 21A and outputs the branched laser light to each of the RFPSs 41 included in the RF side MZM 23A. The RF side MZM 23A includes two RF electrodes 28 and the two RFPSs 41. Each of the RFPSs 41 included in the RF side MZM 23A performs high-speed modulation on the laser light in accordance with the high-speed signal received from the RF electrode 28, and outputs the laser light that has been subjected to high-speed modulation to each of child DCPSs 42 included in the DC side child MZM 24A.

The DC side child MZM 24A includes two DC electrodes 30A, 30B (30) and two child DCPSs 42. The DC electrode 30 is a direct current heater electrode constituted of, for example, a metal material, such as Ti, having a resistance property. Each of the child DCPSs 42 included in the DC side child MZM 24A performs phase modulation on the laser light that has been subjected to high-speed modulation in accordance with the data signal received from the DC electrode 30, and outputs the signal light that has been subjected to phase modulation and that has an I component to the first multiplexing portion 26A. The first multiplexing portion 26A multiplexes the signal light having the I component received from each of the child DCPSs 42, and outputs the multiplexed signal light having the I component to one of parent DCPSs 43 included in the DC side parent MZM 25A.

The DC side child MZM 24B includes the two DC electrodes 30A and 30B (30) and two child DCPSs 42. Each of the child DCPSs 42 included in the DC side child MZM 24B performs phase modulation on the laser light that has been subjected to high-speed modulation in accordance with the data signal received from the DC electrode 30, and outputs the signal light that has been subjected to phase modulation and that has a Q component to the first multiplexing portion 26B. The first multiplexing portion 26B multiplexes the signal light having the Q component received from each of the child DCPSs 42, and outputs the multiplexed signal light having the Q component to the other of the parent DCPSs 43 included in the DC side parent MZM 25A.

The DC side parent MZM 25A includes two DC electrodes 30C (30) and the two parent DCPSs 43. The one parent DCPS 43 included in the DC side parent MZM 25A performs quadrature modulation on the signal light that has been subjected to phase modulation and that has the I component in accordance with the drive voltage signal received from the DC electrode 30C, and outputs the signal light that has been subjected to quadrature modulation and that has an X polarization I component to the second multiplexing portion 27A. The other parent DCPS 43 included in the DC side parent MZM 25A performs quadrature modulation on the signal light that has been subjected to phase modulation and that has the Q component in accordance with the drive voltage signal received from the DC electrode 30C, and outputs the signal light that has been subjected to quadrature modulation and that has an X polarization Q component to the second multiplexing portion 27A.

The second multiplexing portion 27A multiplexes the signal light having the X polarization I component received from the one parent DCPS 43 included in the DC side parent MZM 25A and the signal light having the X polarization Q component received from the other parent DCPS 43 included in the DC side parent MZM 25A. Then, the second multiplexing portion 27A outputs the multiplexed signal light having the X polarization IQ component to the PBC 16.

The Y polarization MZM 14B includes a second branching portion 21B (21), two pieces of third branching portions 22B (22), the two RF side MZMs 23 (23C, 23D), and the two DC side child MZMs 24 (24C, 24D). Furthermore, the Y polarization MZM 14B includes the two first multiplexing portions 26 (26C, 26D), the DC side parent MZM 25 (25B), the second multiplexing portion 27 (27B), and an adjustment unit 32.

The third branching portion 22B branches the laser light received from the second branching portion 21B and outputs the branched laser light to each of the RFPSs 41 included in the RF side MZM 23C. The RF side MZM 23C includes the two RF electrodes 28 and the two RFPSs 41. Each of the RFPSs 41 included in the RF side MZM 23C performs high-speed modulation on the laser light in accordance with the high-speed signal received from the RF electrode 28, and outputs the laser light that has been subjected to high-speed modulation to each of the child DCPSs 42 included in the DC side child MZM 24C.

The DC side child MZM 24C includes the two DC electrodes 30A and 30B (30) and the two child DCPSs 42. Each of the child DCPSs 42 included in the DC side child MZM 24C performs phase modulation on the laser light that has been subjected to high-speed modulation in accordance with the data signal received from the DC electrode 30, and outputs the signal light that has been subjected to phase modulation and that has the I component to the first multiplexing portion 26C. The first multiplexing portion 26C multiplexes the signal light having the I component received from each of the child DCPSs 42, and outputs the multiplex signal light having the I component to the one parent DCPS 43 included in the DC side parent MZM 25B.

The DC side child MZM 24D includes the two DC electrodes 30A and 30B (30) and the two child DCPSs 42. Each of the child DCPSs 42 included in the DC side child MZM 24D performs phase modulation on the laser light that has been subjected to high-speed modulation in accordance with the data signal received from the DC electrode 30, and outputs the signal light that has been subjected to phase modulation and that has the Q component to the first multiplexing portion 26D. The first multiplexing portion 26D multiplexes the signal light having the Q component received from each of the child DCPSs 42, and outputs the multiplexed signal light having the Q component to the other parent DCPS 43 included in the DC side parent MZM 25B.

The DC side parent MZM 25B includes the two DC electrodes 30C (30) and the two parent DCPSs 43. The one parent DCPS 43 included in the DC side parent MZM 25B performs quadrature modulation on the signal light that has been subjected to phase modulation and that has the I component in accordance with the drive voltage signal received from the DC electrode 30C, and outputs the signal light that has been subjected to quadrature modulation and that has a Y polarization I component to the second multiplexing portion 27B. The other parent DCPS 43 included in the DC side parent MZM 25B performs quadrature modulation on the signal light that has been subjected to phase modulation and that has the Q component in accordance with the drive voltage signal received from the DC electrode 30C, and outputs the signal light that has been subjected to quadrature modulation and that has the Y polarization Q component to the second multiplexing portion 27B.

The second multiplexing portion 27B multiplexes the signal light having the Y polarization I component received from the one parent DCPS 43 included in the DC side parent MZM 25B and the signal light having the Y polarization Q component received from the other parent DCPS 43 included in the one DC side parent MZM 25B. Then, the second multiplexing portion 27B outputs the multiplexed signal light having the Y polarization IQ component to the PR 15. The PR 15 performs polarization rotation on the signal light having the Y polarization IQ component received from the second multiplexing portion 27B, and outputs the signal light that has been subjected to polarization rotation and that has the X polarization IQ component to the PBC 16. The PBC 16 performs polarization division multiplexing on the signal light having the X polarization IQ component received from the second multiplexing portion 27A and the signal light having the X polarization IQ component received from the PR 15, and outputs the polarization division multiplexing signal from the optical output portion 17.

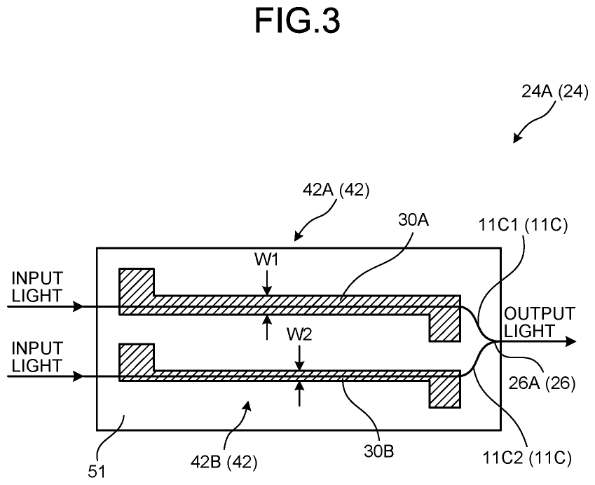

FIG. 3 is a schematic plan view illustrating an example of a configuration of the DC side child MZM 24A according to the first embodiment. Furthermore, for convenience of description, the DC side child MZM 24A will be described, but the DC side child MZMs 24B, 24C, and 24D also have the same configuration as that of the DC side child MZM 24A; therefore, by assigning the same reference numerals to components having the same configuration thereof, overlapped descriptions of the configuration and the operation thereof will be omitted. The DC side child MZM 24A illustrated in FIG. 3 includes a first DCPS 42A that is the child DCPS 42 and that shifts the phase of the first signal light, a second DCPS 42B that is the child DCPS 42 and that shifts the phase of the second signal light, the first multiplexing portion 26A, and a clad layer 51.

The first DCPS 42A includes a first optical waveguide 11C1 through which the first signal light passes, and the first DC electrode 30A that is disposed parallel to the first optical waveguide 11C1 and that heats the first optical waveguide 11C1 by electric power according to a drive voltage. The first DCPS 42A heats the first optical waveguide 11C1 by electric power according to the drive voltage, and causes the optical refractive index of the first optical waveguide 11C1 to be changed by the thermo-optical effect of Si. By causing the optical refractive index of the first optical waveguide 11C1 to be changed, the phase of the first signal light passing through the first optical waveguide 11C1, The first DCPS 42A shifts, and outputs the first signal light obtained after the phase shift has been performed to the first multiplexing portion 26A.

The second DCPS 42B includes a second optical waveguide 11C2 through which the second signal light passes, and the second DC electrode 30B that is disposed parallel to the second optical waveguide 11C2 and that heats the second optical waveguide 11C2 by electric power according to a drive voltage. The second DCPS 42B heats the second optical waveguide 11C2 by the electric power according to the drive voltage, and causes the optical refractive index of the second optical waveguide 11C2 by the thermo-optical effect of Si. By causing the optical refractive index of the second optical waveguide 11C2 to be changed, the second DCPS 42B shifts the phase of the second signal light passing through the second optical waveguide 11C2, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A, the second DCPS 42B, and the first multiplexing portion 26A and that is made of, for example, SiO₂.

An electrode width W2 of the second DC electrode 30B included in the second DCPS 42B is made narrower than an electrode width W1 of the first DC electrode 30A included in the first DCPS 42A. Consequently, an electric resistance of the second DC electrode 30B is higher than that of the first DC electrode 30A.

The electrode width W1 of the first DC electrode 30A is made wider than the electrode width W2 of the second DC electrode 30B. Consequently, the electric current flowing through the first DC electrode 30A is larger than that flowing through the second DC electrode 30B, and the first optical waveguide 11C1 is more heated, so that an amount of phase shift of the first DCPS 42A is increased. In contrast, the electric current flowing through the second DC electrode 30B is smaller than that flowing through the first DC electrode 30A, and the second optical waveguide 11C2 is less heated, so that an amount of phase shift of the second DCPS 42B is decreased.

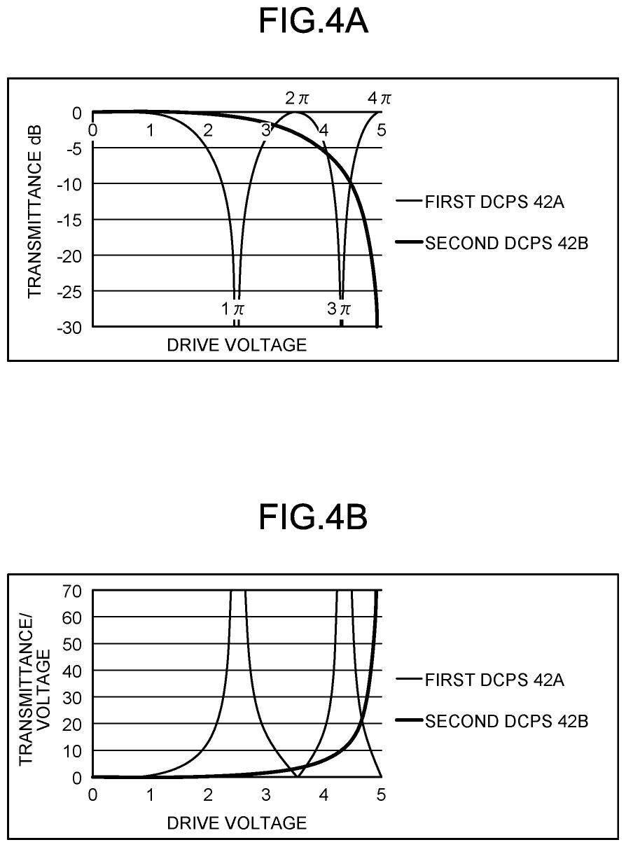

FIG. 4A is a diagram illustrating an example of a relationship between the drive voltage and the output light in the first DCPS 42A and the second DCPS 42B included in the DC side child MZM 24A. It is assumed that the electrode width W2 of the second DC electrode 30B is set to ¼ of the electrode width W1 of the first DC electrode 30A. An amount of phase shift of the second DCPS 42B in the case where a drive voltage of 5 V is applied to the second DC electrode 30B is ¼ of the amount of phase shift of the first DCPS 42A. The relationship between the drive voltage and the output light of the first DCPS 42A and the second DCPS 42B is as illustrated in FIG. 4A.

FIG. 4B is a diagram illustrating an example of an inclination (amount of change) relative to the drive voltage in the first DCPS 42A and the second DCPS 42B included in the DC side child MZM 24A. As illustrated in FIG. 4B, the inclination (amount of change) of the output light relative to the drive voltage in the second DCPS 42B is smaller than that in the first DCPS 42A. As a result, it is possible to implement a fine adjustment of the output light in the second DCPS 42B while ensuring an amount of phase shift of 4π in the first DCPS 42A.

That is, in the DC side child MZM 24A, after the amount of phase shift of 4π is controlled in the first DCPS 42A, a fine adjustment of the output light is performed in the second DCPS 42B. Accordingly, it is possible to easily perform control of the amount of phase shift while compensating phase instability over a long period of time.

In the DC side child MZM 24A according to the first embodiment, the configuration is constituted such that an amount of phase shift according to a predetermined amount of drive voltage in the second DCPS 42B is made smaller than that in the first DCPS 42A. Specifically, the first DC electrode 30A and the second DC electrode 30B are configured such that the electrode width W2 of the second DC electrode 30B included in the second DCPS 42B is narrower than the electrode width W1 of the first DC electrode 30A included in the first DCPS 42A. As a result, it is possible to implement a fine adjustment of the output light by the second DCPS 42B while ensuring the amount of phase shift of 4π in the first DCPS 42A.

Furthermore, for convenience of description, the DC side child MZM 24A has been described, but the DC side parent MZM 25 also has the same configuration as that of the DC side child MZM 24A, so that it can be said that the same effect is obtained.

A case has been described as an example in which the DC side child MZM 24A according to the first embodiment has a structure such that the electrode width W1 of the first DC electrode 30A is made narrower than the electrode width W2 of the second DC electrode 30B. However, the structure may be constituted such that the first DC electrode 30A and the second DC electrode 30B may have the same electrode width, and the number of folds of the first optical waveguide 11C1 and the second optical waveguide 11C2 acting on the DC electrode 30 may be changed, and an embodiment thereof will be described as a second embodiment. In addition, by assigning the same reference numerals to components having the same configuration as those in the optical modulator 5 according to the first embodiment, overlapped descriptions of the configuration and the operation thereof will be omitted.

### (b) Second Embodiment

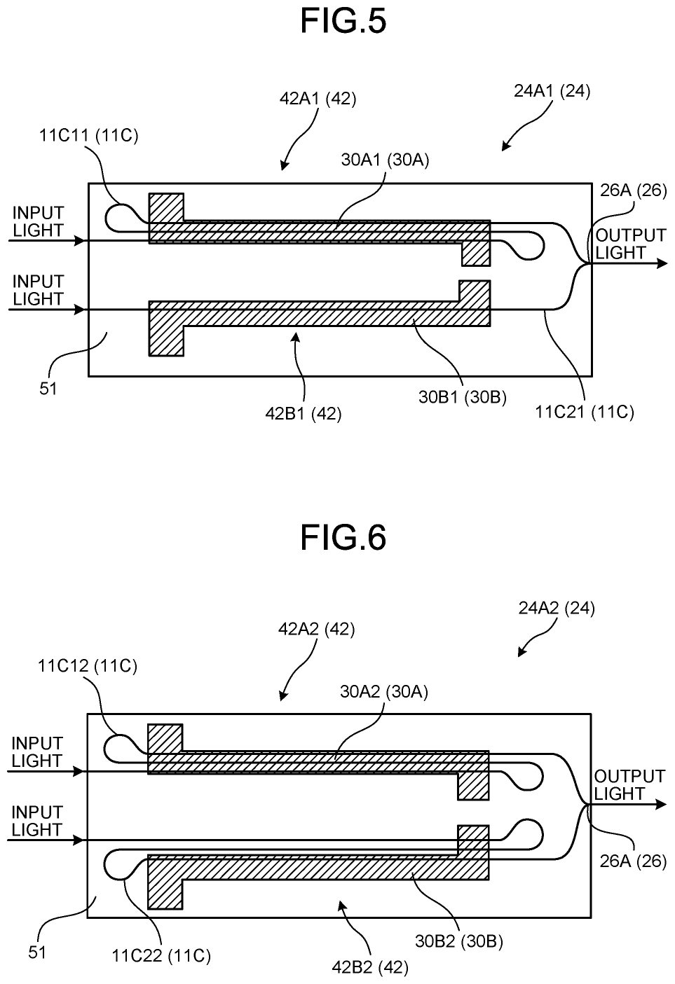

FIG. 5 is a schematic plan view illustrating an example of a configuration of a DC side child MZM 24A1 according to the second embodiment. The DC side child MZM 24A1 illustrated in FIG. 5 includes a first DCPS 42A1 that is the child DCPS 42 and that shifts the phase of the first signal light, a second DCPS 42B1 that is the child DCPS 42 and that shifts the phase of the second signal light, the first multiplexing portion 26A, and the clad layer 51.

The first DCPS 42A1 includes a first optical waveguide 11C11 through which the first signal light passes, and a first DC electrode 30A1 that is disposed parallel to the first optical waveguide 11C11 and that heats the first optical waveguide 11C11 by electric power according to a drive voltage. The first DCPS 42A1 heats the first optical waveguide 11C11 by the electric power according to the drive voltage, and causes the optical refractive index of the first optical waveguide 11C11 to be changed by the thermo-optical effect of Si as a result of heating the first optical waveguide 11C11. By causing the optical refractive index of the first optical waveguide 11C11 to be changed, the first DCPS 42A1 shifts the phase of the first signal light passing through the first optical waveguide 11C11, and outputs the first signal light obtained after the phase shift has been performed to the first multiplexing portion 26A.

The second DCPS 42B1 includes a second optical waveguide 11C21 through which the second signal light passes, and a second DC electrode 30B1 that is disposed parallel to the second optical waveguide 11C21 and that heats the second optical waveguide 11C21 by electric power according to a drive voltage. The second DCPS 42B1 heats the second optical waveguide 11C21 by the electric power according to the drive voltage, and causes the optical refractive index of the second optical waveguide 11C21 to be changed by the thermo-optical effect of Si as a result of heating the second optical waveguide 11C21. By causing the optical refractive index of the second optical waveguide 11C21 to be changed, the second DCPS 42B1 shifts the phase of the second signal light passing through the second optical waveguide 11C21, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A1, the second DCPS 42B1, and the first multiplexing portion 26A and that is made of, for example, SiO₂.

The second optical waveguide 11C21 in which the electric power of the second DC electrode 30B1 included in the second DCPS 42B1 acts is a straight waveguide. In contrast, the first optical waveguide 11C11 in which the electric power of the first DC electrode 30A1 included in the first DCPS 42A1 acts is a folded waveguide that is folded two times. The number of second optical waveguide 11C21 in which the electric power of the second DC electrode 30B1 acts is one, whereas the number of first optical waveguide 11C11 in which the electric power of the first DC electrode 30A1 acts is three. The amount of phase shift relative to the drive voltage in the second DCPS 42B1 is ⅓ of the amount of phase shift relative to the same amount of drive voltage in the first DCPS 42A1. Consequently, it is possible to implement a fine adjustment of output light by the second DCPS 42B1 while ensuring the amount of phase shift of 4π in the first DCPS 42A1.

The DC side child MZM 24A1 according to the second embodiment is constituted such that the waveguide length of the second optical waveguide 11C21 included in the second DCPS 42B1 is shorter than the waveguide length of the first optical waveguide 11C11 included in the first DCPS 42A1. Consequently, it is possible to implement a fine adjustment of output light by the second DCPS 42B1 while ensuring the amount of phase shift of 4π in the first DCPS 42A1.

In addition, the number of folds of the first optical waveguide 11C11 included in the first DCPS 42A1 and the number of folds of the second optical waveguide 11C21 included in and the second DCPS 42B1 are different. Furthermore, the first optical waveguide 11C11 and the second optical waveguide 11C21 are constituted such that the waveguide length of the first optical waveguide 11C11 is longer than the waveguide length of the second optical waveguide 11C21. Consequently, it is possible to implement a fine adjustment of output light by the second DCPS 42B1 while ensuring the amount of phase shift of 4π in the first DCPS 42A1.

However, an optical loss is different due to a difference in the waveguide length between the first optical waveguide 11C11 included in the first DCPS 42A1 and the second optical waveguide 11C21 included in the second DCPS 42B1 according to the second embodiment. Therefore, an imbalance occurs between the first DCPS 42A1 and the second DCPS 42B1. Accordingly, an embodiment of the optical modulator 5 solving this circumstance will be described below as a third embodiment. In addition, by assigning the same reference numerals to components having the same configuration as those in the optical modulator 5 according to the first embodiment, overlapped descriptions of the configuration and the operation thereof will be omitted.

### (c) Third Embodiment

FIG. 6 is a schematic plan view illustrating an example of a configuration of a DC side child MZM 24A2 according to the third embodiment. The DC side child MZM 24A2 illustrated in FIG. 6 includes a first DCPS 42A2 that is the child DCPS 42 and that shifts the phase of the first signal light, a second DCPS 42B2 that is the child DCPS 42 and that shifts the phase of the second signal light, the first multiplexing portion 26A, and the clad layer 51.

The first DCPS 42A2 includes a first optical waveguide 11C12 through which the first signal light passes, and a first DC electrode 30A2 that is disposed parallel to the first optical waveguide 11C12 and that heats the first optical waveguide 11C12 by electric power according to a drive voltage. The first DCPS 42A2 heats the first optical waveguide 11C12 by the electric power according to the drive voltage, and causes the optical refractive index of the first optical waveguide 11C12 to be changed by the thermo-optical effect of Si as a result of heating the first optical waveguide 11C12. By causing the optical refractive index of the first optical waveguide 11C12 to be changed, the first DCPS 42A2 shifts the phase of the first signal light passing through the first optical waveguide 11C12, and outputs the first signal light obtained after the phase shift has been performed to the first multiplexing portion 26A.

The second DCPS 42B2 includes a second optical waveguide 11C22 through which the second signal light passes, and a second DC electrode 30B2 that is disposed parallel to the second optical waveguide 11C22 and that heats the second optical waveguide 11C22 by electric power according to a drive voltage. The second DCPS 42B2 heats the second optical waveguide 11C22 by the electric power according to the drive voltage, and causes the optical refractive index of the second optical waveguide 11C22 to be changed by the thermo-optical effect of Si as a result of heating the second optical waveguide 11C22. By causing the optical refractive index of the second optical waveguide 11C22 to be changed, the second DCPS 42B2 shifts the phase of the second signal light passing through the second optical waveguide 11C22, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A2, the second DCPS 42B2, and the first multiplexing portion 26A and that is made of, for example, SiO₂.

The first optical waveguide 11C12 in which the electric power of the first DC electrode 30A2 included in the first DCPS 42A2 acts is a folded waveguide that is folded two times. The second optical waveguide 11C22 in which the electric power of the second DC electrode 30B2 included in the second DCPS 42B2 acts is also a folded waveguide that is folded two times. The waveguide length of the first optical waveguide 11C12 and that of the second optical waveguide 11C22 are the same. That is, because the waveguide length of the first optical waveguide 11C12 and that of the second optical waveguide 11C22 are the same, an optical loss is substantially the same, and, in addition, the number of folds is also the same, so that a radiation loss of light at each of the folded portions are substantially the same. Consequently, it is possible to improve an extinction ratio in the case where the light is turned OFF while ensuring a balance between the optical waveguides 11C.

The number of first optical waveguides 11C12, in which the electric power of the first DC electrode 30A2 acts, included in the first DCPS 42A2 is three. In contrast, the number of second optical waveguide 11C22, in which the electric power of the second DC electrode 30B2 acts, included in the second DCPS 42B2 is one. The amount of phase shift relative to the drive voltage in the second DCPS 42B2 is ⅓ of the amount of phase shift relative to the same amount of drive voltage in the first DCPS 42A2. Consequently, it is possible to implement a fine adjustment of output light by the second DCPS 42B2 while ensuring the amount of phase shift of 4π in the first DCPS 42A2.

The DC side child MZM 24A2 according to the third embodiment is constituted such that the waveguide length of the first optical waveguide 11C12 included in the first DCPS 42A2 and the waveguide length of the second optical waveguide 11C22 included in the second DCPS 42B2 are the same. Furthermore, the action length in which the electric power of the second DC electrode 30B2 of the second optical waveguide 11C22 included in the second DCPS 42B2 acts is made shorter than the action length in which the electric power of the first DC electrode 30A2 of the first optical waveguide 11C12 included in the first DCPS 42A2 acts. Consequently, it is possible to implement a fine adjustment of output light by the second DCPS 42B2 while ensuring the amount of phase shift of 4π in the first DCPS 42A2. Furthermore, it is also possible to improve the extinction ratio.

Even if the waveguide length of the first optical waveguide 11C1 included in the first DCPS 42A is the same as that of the second optical waveguide 11C2 included in the second DCPS 42B according to the first embodiment, the action length in which the electric power of the first DC electrode 30A acts may be different from the action length in which the electric power of the second DC electrode 30B acts. An embodiment thereof will be described below as a fourth embodiment. In addition, by assigning the same reference numerals to components having the same configuration as those in the optical modulator 5 according to the first embodiment, overlapped descriptions of the configuration and the operation thereof will be omitted.

### (d) Fourth Embodiment

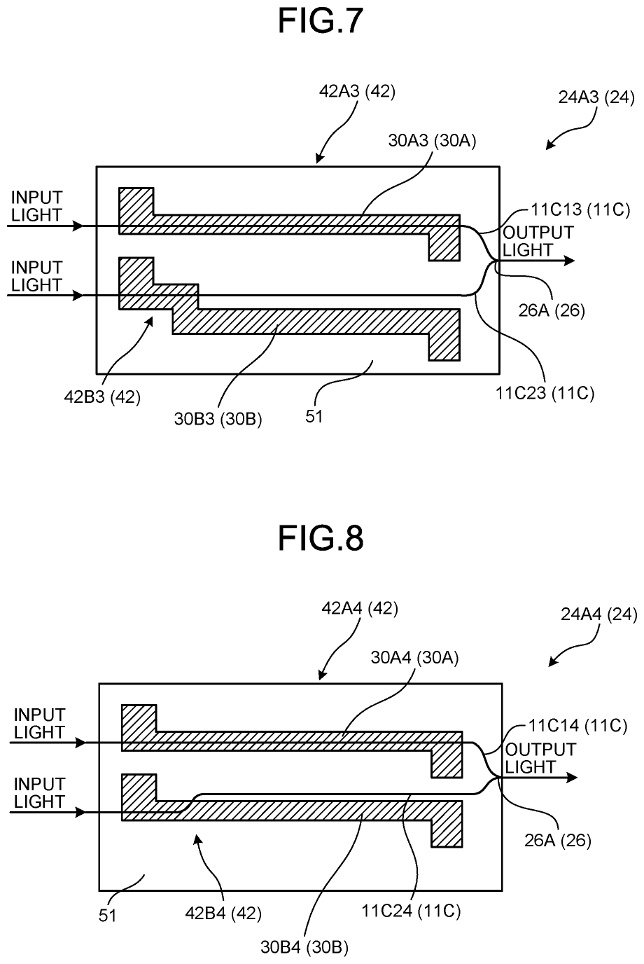

FIG. 7 is a schematic plan view illustrating an example of a configuration of a DC side child MZM 24A3 according to the fourth embodiment. The DC side child MZM 24A3 illustrated in FIG. 7 includes a first DCPS 42A3 that is the child DCPS 42 and that shifts the phase of the first signal light, a second DCPS 42B3 that is the child DCPS 42 and that shifts the phase of the second signal light, the first multiplexing portion 26A, and the clad layer 51.

The first DCPS 42A3 includes a first optical waveguide 11C13 through which the first signal light passes, and a first DC electrode 30A3 that is disposed parallel to the first optical waveguide 11C13 and that heats the first optical waveguide 11C13 by electric power according to a drive voltage. The first DCPS 42A3 heats the first optical waveguide 11C13 by the electric power according to the drive voltage, and causes the optical refractive index of the first optical waveguide 11C13 to be changed by the thermo-optical effect of Si as a result of heating the first optical waveguide 11C13. By causing the optical refractive index of the first optical waveguide 11C13 to be changed, the first DCPS 42A3 shifts the phase of the first signal light passing through the first optical waveguide 11C13, and outputs the first signal light obtained after the phase shift has been performed to the first multiplexing portion 26A.

The second DCPS 42B3 includes a second optical waveguide 11C23 through which the second signal light passes, and a second DC electrode 30B3 that is disposed parallel to the second optical waveguide 11C23 and that heats the second optical waveguide 11C23 by electric power according to a drive voltage. The second DCPS 42B3 heats the second optical waveguide 11C23 by the electric power according to the drive voltage, and causes the optical refractive index of the second optical waveguide 11C23 to be changed by the thermo-optical effect of Si as a result of heating the second optical waveguide 11C23. By causing the optical refractive index of the second optical waveguide 11C23 to be changed, the second DCPS 42B3 shifts the phase of the second signal light passing through the second optical waveguide 11C23, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A3, the second DCPS 42B3, and the first multiplexing portion 26A and that is made of, for example, SiO₂.

The waveguide length of the first optical waveguide 11C13 included in the first DCPS 42A3 is the same as that of the second optical waveguide 11C23 included in the second DCPS 42B3.

The second DC electrode 30B3 is constituted such that a part of the second DC electrode 30B3 is bent so as to be away from the second optical waveguide 11C23. The action length of the second optical waveguide 11C23 in which the electric power of the second DC electrode 30B3 included in the second DCPS 42B3 acts is made shorter than the action length of the first optical waveguide 11C13 in which the electric power of the first DC electrode 30A3 included in the first DCPS 42A3 acts. The amount of phase shift relative to the drive voltage in the second DCPS 42B3 is ⅓ of the amount of phase shift relative to the same amount of drive voltage in the first DCPS 42A3. Consequently, it is possible to implement a fine adjustment of the output light by the second DCPS 42B3 while ensuring the amount of phase shift of 4π in the first DCPS 42A3.

The DC side child MZM 24A3 according to the fourth embodiment is constituted such that the waveguide length of the first optical waveguide 11C13 included in the first DCPS 42A3 is the same as the waveguide length of the second optical waveguide 11C23 included in the second DCPS 42B3. Furthermore, the action length in which the electric power of the second DC electrode 30B3 of the second optical waveguide 11C23 included in the second DCPS 42B3 acts is made shorter than the action length in which the electric power of the first DC electrode 30A3 of the first optical waveguide 11C13 included in the first DCPS 42A3 acts. Consequently, it is possible to implement a fine adjustment of the output light by the second DCPS 42B2 while ensuring the amount of phase shift of 4π in the first DCPS 42A2. Furthermore, it is also possible to improve the extinction ratio.

The configuration of the DC side child MZM 24A according to the first embodiment is not limited to the examples described above, and appropriate modifications are possible. An embodiment thereof will be described below as a seventh embodiment. In addition, by assigning the same reference numerals to components having the same configuration as those in the optical modulator 5 according to the first embodiment, overlapped descriptions of the configuration and the operation thereof will be omitted.

### (e) Fifth Embodiment

FIG. 8 is a schematic plan view illustrating an example of a configuration of a DC side child MZM 24A4 according to the fifth embodiment. The DC side child MZM 24A4 illustrated in FIG. 8 includes a first DCPS 42A4 that is the child DCPS 42 and that shifts the phase of the first signal light, a second DCPS 42B4 that is the child DCPS 42 and that shifts the phase of the second signal light, the first multiplexing portion 26A, and the clad layer 51.

The first DCPS 42A4 includes a first optical waveguide 11C14 through which the first signal light passes, and a first DC electrode 30A4 that is disposed parallel to the first optical waveguide 11C14 and that heats the first optical waveguide 11C14 by electric power according to a drive voltage. The first DCPS 42A4 heats the first optical waveguide 11C14 by the electric power according to the drive voltage, and causes the optical refractive index of the first optical waveguide 11C14 to be changed by the thermo-optical effect of Si as a result of heating the first optical waveguide 11C14. By causing the optical refractive index of the first optical waveguide 11C14 to be changed, the first DCPS 42A4 shifts the phase of the first signal light passing through the first optical waveguide 11C14, and outputs the first signal light obtained after the phase shift has been performed to the first multiplexing portion 26A.

The second DCPS 42B4 includes a second optical waveguide 11C24 through which the second signal light passes, and a second DC electrode 30B4 that is disposed parallel to the second optical waveguide 11C24 and that heats the second optical waveguide 11C24 by electric power according to a drive voltage. The second DCPS 42B4 heats the second optical waveguide 11C24 by the electric power according to the drive voltage, and causes the optical refractive index of the second optical waveguide 11C24 to be changed by the thermo-optical effect of Si as a result of heating the second optical waveguide 11C24. By causing the optical refractive index of the second optical waveguide 11C24 to be changed, the second DCPS 42B4 shifts the phase of the second signal light passing through the second optical waveguide 11C24, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A4, the second DCPS 42B4, and the first multiplexing portion 26A and that is made of, for example, SiO₂.

The first optical waveguide 11C14 included in the first DCPS 42A4 is a straight waveguide, whereas the second optical waveguide 11C24 included in the second DCPS 42B4 includes a straight waveguide and a bent waveguide. The second optical waveguide 11C24 is in a state away from the second DC electrode 30B4 due to the bent waveguide. The waveguide length of the first optical waveguide 11C14 is different from the waveguide length of the second optical waveguide 11C24.

The action length of the second optical waveguide 11C24 in which the electric power of the second DC electrode 30B4 included in the second DCPS 42B4 acts is shorter than the action length of the first optical waveguide 11C14 in which the electric power of the first DC electrode 30A4 included in the first DCPS 42A4 acts. The amount of phase shift relative to the drive voltage in the second DCPS 42B4 is ⅓ of the amount of phase shift relative to the same drive voltage in the first DCPS 42A4. Consequently, it is possible to implement a fine adjustment of the output light in the second DCPS 42B4 while ensuring the amount of phase shift of 4π in the first DCPS 42A4.

The DC side child MZM 24A4 according to the fifth embodiment is constituted such that the first optical waveguide 11C14 included in the first DCPS 42A4 is a straight waveguide and the second optical waveguide 11C24 included in the second DCPS 42B4 is a bent waveguide. In the DC side child MZM 24A4, the bent waveguide of the second optical waveguide 11C24 is disposed such that the action length in which the electric power of the second DC electrode 30B4 of the second optical waveguide 11C24 included in the second DCPS 42B4 acts is shorter than the action length in which the electric power of the first DC electrode 30A4 of the first optical waveguide 11C14 included in the first DCPS 42A4 acts. Consequently, it is possible to implement a fine adjustment of the output light by the second DCPS 42B4 while ensuring the amount of phase shift of 4π in the first DCPS 42A4.

The waveguide length of the first optical waveguide 11C1 included in the first DCPS 42A is the same as the waveguide length of the second optical waveguide 11C2 included in the second DCPS 42B according to the first embodiment, but the electrode length of the second DC electrode 30B is made longer than the electrode length of the first DC electrode 30A. An embodiment thereof will be described below as a sixth embodiment. In addition, by assigning the same reference numerals to components having the same configuration as those in the optical modulator 5 according to the first embodiment, overlapped descriptions of the configuration and the operation thereof will be omitted.

### (f) Sixth Embodiment

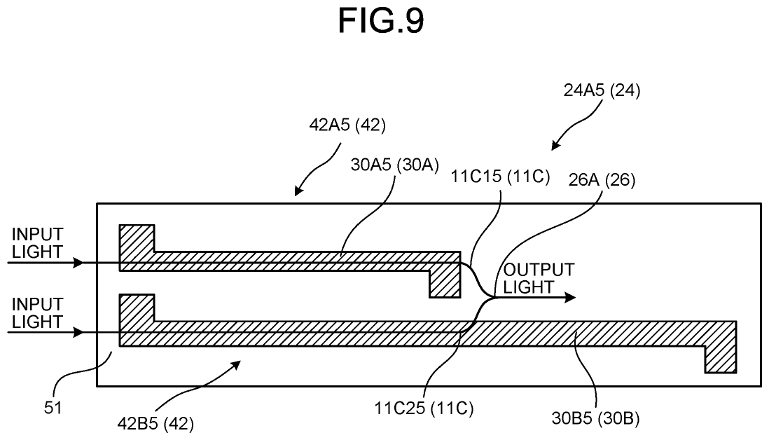

FIG. 9 is a schematic plan view illustrating an example of a configuration of a DC side child MZM 24A5 according to the sixth embodiment. The DC side child MZM 24A5 illustrated in FIG. 9 includes a first DCPS 42A5 that is the child DCPS 42 and that shifts the phase of the first signal light, a second DCPS 42B5 that is the child DCPS 42 and that shifts the phase of the second signal light, the first multiplexing portion 26A, and the clad layer 51.

The first DCPS 42A5 includes a first optical waveguide 11C15 through which the first signal light passes, and a first DC electrode 30A5 that is disposed parallel to the first optical waveguide 11C15 and that heats the first optical waveguide 11C15 by electric power according to a drive voltage. The first DCPS 42A5 heats the first optical waveguide 11C15 by the electric power according to the drive voltage, and causes the optical refractive index of the first optical waveguide 11C15 to be changed by the thermo-optical effect of Si as a result of heating the first optical waveguide 11C15. By causing the optical refractive index of the first optical waveguide 11C15 to be changed, the first DCPS 42A5 shifts the phase of the first signal light passing through the first optical waveguide 11C15, and outputs the first signal light obtained after the phase shift has been performed to the first multiplexing portion 26A.

The second DCPS 42B5 includes a second optical waveguide 11C25 through which the second signal light passes, and a second DC electrode 30B5 that is disposed parallel to the second optical waveguide 11C25 and that heats the second optical waveguide 11C25 by electric power according to a drive voltage. The second DCPS 42B5 heats the second optical waveguide 11C25 by the electric power according to the drive voltage, and causes the optical refractive index of the second optical waveguide 11C25 to be changed by the thermo-optical effect of Si as a result of heating the second optical waveguide 11C25. By causing the optical refractive index of the second optical waveguide 11C25 to be changed, the second DCPS 42B5 shifts the phase of the second signal light passing through the second optical waveguide 11C25, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A5, the second DCPS 42B5, and the first multiplexing portion 26A and that is made of, for example, SiO₂.

The first optical waveguide 11C15 included in the first DCPS 42A5 and the second optical waveguide 11C25 included in the second DCPS 42B5 are straight waveguides. The waveguide length of the first optical waveguide 11C15 is the same as the waveguide length of the second optical waveguide 11C25.

The electrode length of the second DC electrode 30B5 included in the second DCPS 42B5 is longer than the electrode length of the first DC electrode 30A5 included in the first DCPS 42A5. The amount of phase shift relative to the drive voltage in the second DCPS 42B5 is ⅓ of the amount of phase shift relative to the same amount of drive voltage in the first DCPS 42A5. Consequently, it is possible to implement a fine adjustment of the output light by the second DCPS 42B5 while ensuring the amount of phase shift of 4π in the first DCPS 42A5.

The DC side child MZM 24A5 according to the sixth embodiment is constituted such that the waveguide length of the first optical waveguide 11C15 included in the first DCPS 42A5 is the same as the waveguide length of the second optical waveguide 11C25 included in the second DCPS 42B5. Furthermore, the DC side child MZM 24A5 is constituted such that the electrode length of the second DC electrode 30B5 included in the second DCPS 42B5 is longer than the electrode length of the first DC electrode 30A5 included in the first DCPS 42A5. Consequently, it is possible to implement a fine adjustment of the output light by the second DCPS 42B5 while ensuring the amount of phase shift of 4π in the first DCPS 42A5.

The configuration of the DC side child MZM 24 according to the first embodiment is not limited to this, and appropriate modifications are possible. An embodiment thereof will be described below as a seventh embodiment. In addition, by assigning the same reference numerals to components having the same configuration as those in the optical modulator 5 according to the first embodiment, overlapped descriptions of the configuration and the operation thereof will be omitted.

### (g) Seventh Embodiment

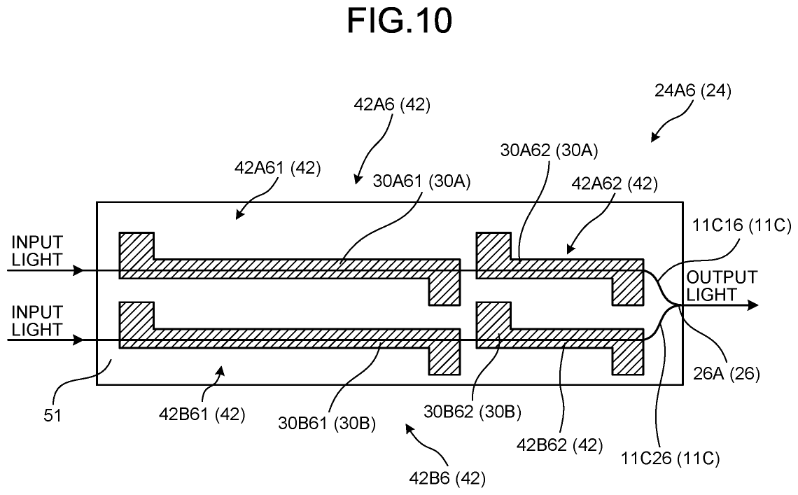

FIG. 10 is a schematic plan view illustrating an example of a configuration of a DC side child MZM 24A6 according to the seventh embodiment. The DC side child MZM 24A6 illustrated in FIG. 10 includes a first DCPS 42A6 that is the child DCPS 42 and that shifts the phase of the first signal light, a second DCPS 42B6 that is the child DCPS 42 that shifts the phase of the second signal light, the first multiplexing portion 26A, and the clad layer 51.

The first DCPS 42A6 includes a first optical waveguide 11C16 through which the first signal light passes, a third DCPS 42A61, and a fourth DCPS 42A62. The third DCPS 42A61 includes a first DC electrode 30A61 that is disposed parallel to the first optical waveguide 11C16 and that heats the first optical waveguide 11C16 by electric power according to a drive voltage. The third DCPS 42A61 heats the first optical waveguide 11C16 by the electric power according to the drive voltage, and causes the optical refractive index of the first optical waveguide 11C16 to be changed by the thermo-optical effect of Si as a result of heating the first optical waveguide 11C16. By causing the optical refractive index of the first optical waveguide 11C16 to be changed, the third DCPS 42A61 shifts the phase of the first signal light passing through the first optical waveguide 11C16, and outputs the first signal light obtained after the phase shift has been performed to the fourth DCPS 42A62.

The fourth DCPS 42A62 includes a first DC electrode 30A62 that is disposed parallel to the first optical waveguide 11C16 and that heats the first optical waveguide 11C16 by electric power according to a drive voltage. The fourth DCPS 42A62 heats the first optical waveguide 11C16 by the electric power according to the drive voltage, and causes the optical refractive index of the first optical waveguide 11C16 to be changed by the thermo-optical effect of Si as a result of heating the first optical waveguide 11C16. By causing the optical refractive index of the first optical waveguide 11C16 to be changed, the fourth DCPS 42A62 shifts the phase of the first signal light passing through the first optical waveguide 11C16, and outputs the first signal light obtained after the phase shift has been performed to the first multiplexing portion 26A.

The second DCPS 42B6 includes a second optical waveguide 11C26 through which the second signal light passes, a third DCPS 42B61, and a fourth DCPS 42B62. The third DCPS 42B61 includes a second DC electrode 30B61 that is disposed parallel to the second optical waveguide 11C26 and that heats the second optical waveguide 11C26 by electric power according to a drive voltage. The third DCPS 42B61 heats the second optical waveguide 11C26 by the electric power according to the drive voltage, and causes the optical refractive index of the second optical waveguide 11C26 to be changed by the thermo-optical effect of Si as a result of the second optical waveguide 11C26. By causing the optical refractive index of the second optical waveguide 11C26 to be changed, the third DCPS 42B61 shifts the phase of the second signal light passing through the second optical waveguide 11C26, and outputs the second signal light obtained after the phase shift has been performed to the fourth DCPS 42B62.

The fourth DCPS 42B62 includes a second DC electrode 30B62 that is disposed parallel to the second optical waveguide 11C26 and that heats the second optical waveguide 11C26 by electric power according to a drive voltage. The fourth DCPS 42B62 heats the second optical waveguide 11C26 by the electric power according to the drive voltage, and causes the optical refractive index of the second optical waveguide 11C26 to be changed by the thermo-optical effect of Si as a result of heating the second optical waveguide 11C26. By causing the optical refractive index of the second optical waveguide 11C26 to be changed, the fourth DCPS 42B62 shifts the phase of the second signal light passing through the second optical waveguide 11C26, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A6, the second DCPS 42B6, and the first multiplexing portion 26A and that is made of, for example, SiO₂.

The first optical waveguide 11C16 included in the first DCPS 42A6 and the second optical waveguide 11C26 included in the second DCPS 42B6 are straight waveguides. The waveguide length of the first optical waveguide 11C16 and the waveguide length of the second optical waveguide 11C26 are the same.

The electrode length of the first DC electrode 30A61 included in the first DCPS 42A6 is the same as the electrode length of the second DC electrode 30B61 included in the second DCPS 42B6. The electrode length of the first DC electrode 30A62 included in the first DCPS 42A6 is the same as the electrode length of the second DC electrode 30B62 included in the second DCPS 42B6. The electrode length of the first DC electrode 30A62 included in the first DCPS 42A6 is made shorter than the electrode length of the first DC electrode 30A61 included in the first DCPS 42A6. The electrode length of the second DC electrode 30B62 included in the second DCPS 42B6 is made shorter than the electrode length of the second DC electrode 30B61 included in the second DCPS 42B6.

The electrode length of the first DC electrode 30A62 included in the first DCPS 42A6 is made shorter than the electrode length of the first DC electrode 30A61 included in the first DCPS 42A6. The amount of phase shift relative to the drive voltage in the fourth DCPS 42A62 is ⅓ of the amount of phase shift relative to the same drive voltage in the third DCPS 42A61. The fourth DCPS 42A62 makes a fine adjustment of the optical refractive index of the first optical waveguide 11C16 in accordance with the electric power acted by the first DC electrode 30A62. Furthermore, the third DCPS 42A61 adjusts the optical refractive index of the first optical waveguide 11C16 in accordance with the electric power acted by the first DC electrode 30A61. Consequently, it is possible to implement a fine adjustment of the output light by the third DCPS 42A61 while ensuring the amount of phase shift of 4π in the fourth DCPS 42A62.

The electrode length of the second DC electrode 30B62 included in the second DCPS 42B6 is made shorter than the electrode length of the second DC electrode 30B61 included in the second DCPS 42B6. The amount of phase shift relative to the drive voltage in the fourth DCPS 42B62 is ⅓ of the amount of phase shift relative to the same drive voltage in the third DCPS 42B61. The fourth DCPS 42B62 makes a fine adjustment of the optical refractive index of the second optical waveguide 11C26 in accordance with the electric power acted by the second DC electrode 30B62. The third DCPS 42B61 adjusts the optical refractive index of the second optical waveguide 11C26 in accordance with the electric power acted by the second DC electrode 30B61. Consequently, it is possible to implement a fine adjustment of the output light by the third DCPS 42B61 while ensuring the amount of phase shift of 4π in the fourth DCPS 42B62.

In the first DCPS 42A6 according to the seventh embodiment, the third DCPS 42A61 that includes the first DC electrode 30A61 and the fourth DCPS 42A62 that includes the first DC electrode 30A62 are disposed in series. Then, the electrode length of the first DC electrode 30A62 is made shorter than the electrode length of the first DC electrode 30A61. Consequently, the fourth DCPS 42A62 is constituted such that the amount of phase shift is smaller than that in the third DCPS 42A61 according to a predetermined amount of drive voltage. Consequently, it is possible to implement a fine adjustment of the output light by the third DCPS 42A61 while ensuring the amount of phase shift of 4π in the fourth DCPS 42A62.

### (h) Eighth Embodiment

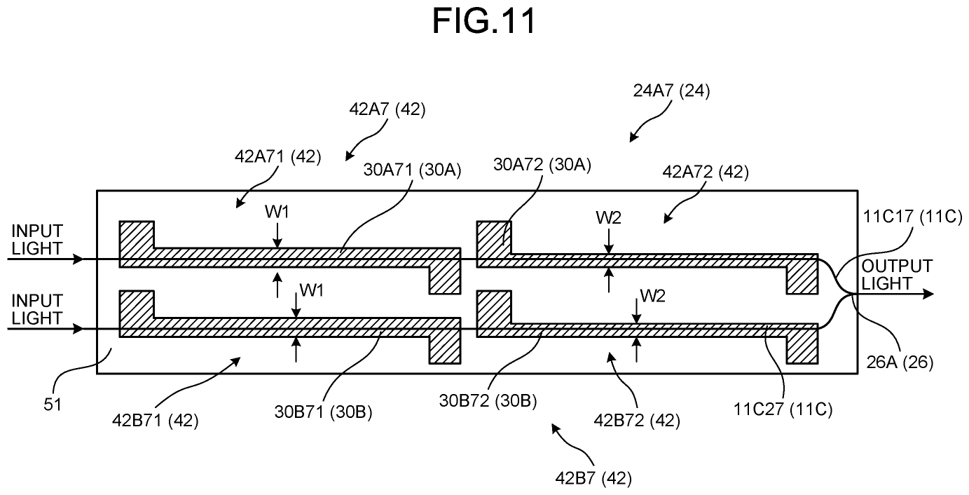

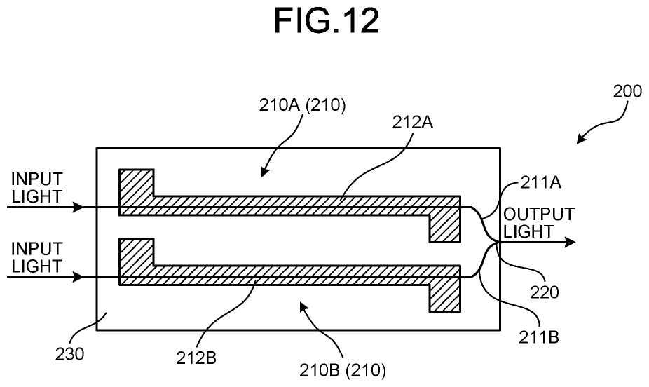

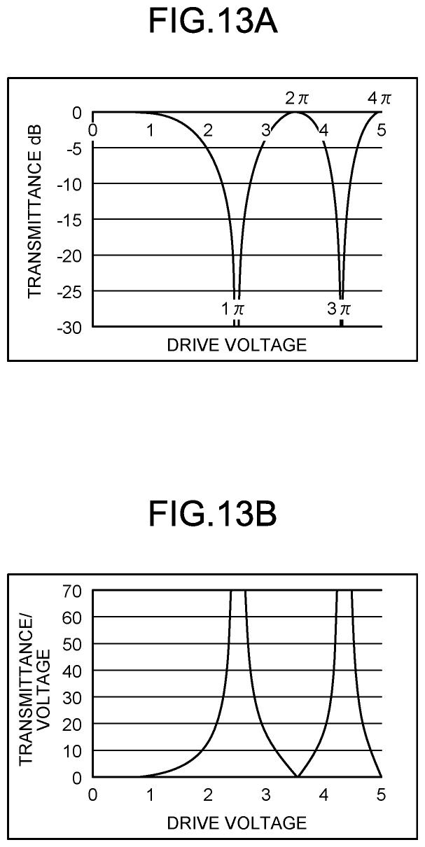

FIG. 11 is a schematic plan view illustrating an example of a configuration of a DC side child MZM 24A7 according to an eighth embodiment. The DC side child MZM 24A7 illustrated in FIG. 11 includes a first DCPS 42A7 that is the child DCPS 42 and that shifts the phase of the first signal light, a second DCPS 42B7 that is the child DCPS 42 that shifts the phase of the second signal light, the first multiplexing portion 26A, and the clad layer 51.

The first DCPS 42A7 includes a first optical waveguide 11C17 through which the first signal light passes, a third DCPS 42A71, and a fourth DCPS 42A72. The third DCPS 42A71 includes a first DC electrode 30A71 that is disposed parallel to the first optical waveguide 11C17 and that heats the first optical waveguide 11C17 by electric power according to a drive voltage. The third DCPS 42A71 heats the first optical waveguide 11C17 by the electric power according to the drive voltage, and causes the optical refractive index of the first optical waveguide 11C17 to be changed by the thermo-optical effect of Si as a result of heating the first optical waveguide 11C17. By causing the optical refractive index of the first optical waveguide 11C17 to be changed, the third DCPS 42A71 shifts the phase of the first signal light passing through the first optical waveguide 11C17, and outputs the first signal light obtained after the phase shift has been performed to the fourth DCPS 42A72.

The fourth DCPS 42A72 includes a first DC electrode 30A72 that is disposed parallel to the first optical waveguide 11C17 and that heats the first optical waveguide 11C17 by electric power according to a drive voltage. The fourth DCPS 42A72 heats the first optical waveguide 11C17 by the electric power according to the drive voltage, and causes the optical refractive index of the first optical waveguide 11C17 to be changed by the thermo-optical effect of Si as a result of heating the first optical waveguide 11C17. By causing the optical refractive index of the first optical waveguide 11C17 to be changed, the fourth DCPS 42A72 shifts the phase of the first signal light passing through the first optical waveguide 11C17, and outputs the first signal light obtained after the phase shift has been performed to the first multiplexing portion 26A.

The second DCPS 42B7 includes a second optical waveguide 11C27 through which the second signal light passes, a third DCPS 42B71, and a fourth DCPS 42B72. The third DCPS 42B71 includes a second DC electrode 30B71 that is disposed parallel to the second optical waveguide 11C27 and that heats the second optical waveguide 11C27 by electric power according to a drive voltage. The third DCPS 42B71 heats the second optical waveguide 11C27 by the electric power according to the drive voltage, and causes the optical refractive index of the second optical waveguide 11C27 to be changed by the thermo-optical effect of Si as a result of heating the second optical waveguide 11C27. By causing the optical refractive index of the second optical waveguide 11C27 to be changed, the third DCPS 42B71 shifts the phase of the second signal light passing through the second optical waveguide 11C27, and outputs the second signal light obtained after the phase shift has been performed to the fourth DCPS 42B72.

The fourth DCPS 42B72 includes a second DC electrode 30B72 that is disposed parallel to the second optical waveguide 11C27 and that heats the second optical waveguide 11C27 by the electric power according to a drive voltage. The fourth DCPS 42B72 heats the second optical waveguide 11C27 by the electric power according to the drive voltage, and causes the optical refractive index of the second optical waveguide 11C27 to be changed by the thermo-optical effect of Si as a result of heating the second optical waveguide 11C27. By causing the optical refractive index of the second optical waveguide 11C27 to be changed, the fourth DCPS 42B72 shifts the phase of the second signal light passing through the second optical waveguide 11C27, and outputs the second signal light obtained after the phase shift has been performed to the first multiplexing portion 26A.

The first multiplexing portion 26A multiplexes the first signal light obtained after the phase shift has been performed and the second signal light obtained after the phase shift has been performed. The clad layer 51 is a layer that covers the first DCPS 42A7, the second DCPS 42B7, and the first multiplexing portion 26A and that is made of, for example, SiO₂.

The first optical waveguide 11C17 included in the first DCPS 42A7 and the second optical waveguide 11C27 included in the second DCPS 42B7 are straight waveguides. The waveguide length of the first optical waveguide 11C17 and the waveguide length of the second optical waveguide 11C27 are the same.

The electrode length of the first DC electrode 30A71 included in the first DCPS 42A7 is the same as the electrode length of the second DC electrode 30B71 included in the second DCPS 42B7. The electrode length of the first DC electrode 30A72 included in the first DCPS 42A7 is the same as the electrode length of the second DC electrode 30B72 included in the second DCPS 42B7.

The electrode width W2 of the first DC electrode 30A72 included in the first DCPS 42A7 is made narrower than the electrode width W1 of the first DC electrode 30A71. The electrode width W2 of the second DC electrode 30B72 included in the second DCPS 42B7 is made narrower than the electrode width W1 of the second DC electrode 30B71.

The electrode width of the first DC electrode 30A72 included in the fourth DCPS 42A72 is made narrower than the electrode width of the first DC electrode 30A71 included in the third DCPS 42A71. The amount of phase shift relative to the drive voltage in the fourth DCPS 42A72 is ⅓ of the amount of phase shift relative to the same drive voltage in the third DCPS 42A71. The third DCPS 42A71 adjusts the optical refractive index of the first optical waveguide 11C17 in accordance with the electric power acted by the first DC electrode 30A71. The fourth DCPS 42A72 makes a fine adjustment of the optical refractive index of the first optical waveguide 11C17 in accordance with the electric power acted by the first DC electrode 30A72. Consequently, it is possible to implement a fine adjustment of the output light by the fourth DCPS 42A72 while ensuring the amount of phase shift of 4π in the third DCPS 42A71.

The electrode width of the second DC electrode 30B72 included in the fourth DCPS 42B72 is made narrower than the electrode width of the second DC electrode 30B71 included in the third DCPS 42B71. The amount of phase shift relative to the drive voltage in the fourth DCPS 42B72 is ⅓ of the amount of phase shift relative to the same drive voltage in the third DCPS 42B71. The third DCPS 42B71 adjusts the optical refractive index of the second optical waveguide 11C27 in accordance with the electric power acted by the second DC electrode 30B71. The fourth DCPS 42B72 makes a fine adjustment of the optical refractive index of the second optical waveguide 11C27 in accordance with the electric power acted by the second DC electrode 30B72. Consequently, it is possible to implement a fine adjustment of the output light by the fourth DCPS 42B72 while ensuring the amount of phase shift of 4π in the third DCPS 42B71.

The first DCPS 42A7 according to the eighth embodiment has a structure in which the third DCPS 42A71 that includes the first DC electrode 30A71 and a fourth DCPS 62A72 that includes the first DC electrode 30A72 are disposed in series. Then, the electrode width of the first DC electrode 30A72 is made narrower than the electrode width of the first DC electrode 30A71. Consequently, the fourth DCPS 42A72 is constituted such that the amount of phase shift is smaller than that in the third DCPS 42A71 in accordance with a predetermined amount of drive voltage. Consequently, it is possible to implement a fine adjustment of the output light by the third DCPS 42A71 while ensuring the amount of phase shift of 4π in the fourth DCPS 42A72.

In addition, for convenience of description, the DC side child MZM 24 has been described as an example of the optical modulator according to the embodiment; however, the DC side parent MZM 25 may be applied, and appropriate modifications are possible.

In the present embodiment, a case has been described as an example of a polarization division multiplexing technique for performing polarization division multiplexing on the X polarization signal light received from the X polarization MZM 14A and the Y polarization signal light received from the Y polarization MZM 14B; however, for example, the present embodiment can be applied to an optical modulator used in a technique in which polarization division multiplexing is not performed.

According to an aspect of an embodiment of the optical modulator and the like disclosed in the present invention, it is possible to implement a fine adjustment of output light while ensuring an amount of phase shift.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator comprising:
a first phase shifter
that includes
a first optical waveguide through which first signal light passes, and
a first direct current electrode that is disposed parallel to the first optical waveguide and that causes electric power according to a drive voltage to act on the first optical waveguide, and
that shifts a phase of the first signal light passing through the first optical waveguide in accordance with the drive voltage applied to the first direct current electrode; and
a second phase shifter
that includes
a second optical waveguide through which second signal light passes, and
a second direct current electrode that is disposed parallel to the second optical waveguide and that causes electric power according to a drive voltage to act on the second optical waveguide, and
that shifts a phase of the second signal light passing through the second optical waveguide in accordance with the drive voltage applied to the second direct current electrode, wherein
the second phase shifter is constituted to have a smaller amount of phase shift according to a predetermined amount of drive voltage than the first phase shifter.

2. The optical modulator according to claim 1, wherein the first direct current electrode and the second direct current electrode are constituted such that an electrode width of the second direct current electrode included in the second phase shifter is narrower than an electrode width of the first direct current electrode included in the first phase shifter.

3. The optical modulator according to claim 1, wherein the first optical waveguide and the second optical waveguide are constituted such that a waveguide length of the second optical waveguide included in the second phase shifter is shorter than a waveguide length of the first optical waveguide included in the first phase shifter.

4. The optical modulator according to claim 1, wherein the first optical waveguide and the second optical waveguide are constituted such that
a number of times the first optical waveguide included in the first phase shifter is folded is different from the number of times the second optical waveguide included in the second phase shifter is folded, and
a waveguide length of the first optical waveguide is longer than a waveguide length of the second optical waveguide.

5. The optical modulator according to claim 1, wherein the second direct current electrode is disposed such that
a waveguide length of the first optical waveguide included in the first phase shifter is the same as a waveguide length of the second optical waveguide included in the second phase shifter, and
an action length in which the electric power of the second direct current electrode of the second optical waveguide included in the second phase shifter acts is shorter than an action length in which the electric power of the first direct current electrode of the first optical waveguide included in the first phase shifter acts.

6. The optical modulator according to claim 1, wherein a bent waveguide of the second optical waveguide is disposed such that
the first optical waveguide included in the first phase shifter is constituted to be a straight waveguide and the second optical waveguide of the second phase shifter is constituted to be a bent waveguide, and
an action length in which the electric power of the second direct current electrode of the second optical waveguide included in the second phase shifter acts is shorter than an action length in which the electric power of the first direct current electrode of the first optical waveguide included in the first phase shifter acts.

7. The optical modulator according to claim 1, wherein the first direct current electrode and the second direct current electrode are constituted such that
a waveguide length of the first optical waveguide included in the first phase shifter is the same as a waveguide length of the second optical waveguide included in the second phase shifter, and
an electrode length of the second direct current electrode included in the second phase shifter is longer than an electrode length of the first direct current electrode included in the first phase shifter.

8. A phase shifter comprising:
an optical waveguide through which signal light passes;
a first phase shifter
that includes a first direct current electrode that is disposed parallel to the optical waveguide and that causes electric power according to a drive voltage to act on the optical waveguide, and
that shifts a phase of the signal light passing through the optical waveguide in accordance with the drive voltage applied to the first direct current electrode; and
a second phase shifter
that includes a second direct current electrode that is disposed parallel to the optical waveguide and that causes electric power according to a drive voltage to act on the optical waveguide,
that is connected to the first phase shifter in series, and
that shifts a phase of the signal light passing through the optical waveguide in accordance with the drive voltage applied to the second direct current electrode, wherein
the second phase shifter is constituted to have a smaller amount of phase shift according to a predetermined amount of drive voltage than the first phase shifter.

9. The phase shifter according to claim 8, wherein the first direct current electrode and the second direct current electrode are constituted such that an electrode length of the second direct current electrode included in the second phase shifter is shorter than an electrode length of the first direct current electrode included in the first phase shifter.

10. The phase shifter according to claim 8, wherein the first direct current electrode and the second direct current electrode are constituted such that an electrode width of the second direct current electrode included in the second phase shifter is narrower than an electrode width of the first direct current electrode included in the first phase shifter.

11. An optical communication apparatus comprising:
a processor that executes signal processing on an electrical signal;
a light source that emits signal light; and
an optical modulator that modulates the signal light emitted from the light source by using the electrical signal that is output from the processor, wherein
the optical modulator includes
a first phase shifter
that includes
a first optical waveguide through which first signal light out of the signal light received from the light source passes, and
a first direct current electrode that is disposed parallel to the first optical waveguide and that causes electric power according to a drive voltage to act on the first optical waveguide, and
that shifts a phase of the first signal light passing through the first optical waveguide in accordance with the drive voltage applied to the first direct current electrode,
a second phase shifter
that includes
a second optical waveguide through which second signal light out of the signal light received from the light source passes, and
a second direct current electrode that is disposed parallel to the second optical waveguide and that causes electric power according to a drive voltage to act on the second optical waveguide, and
that shifts a phase of the second signal light passing through the second optical waveguide in accordance with the drive voltage applied to the second direct current electrode, and
a multiplexer that multiplexes the first signal light obtained after a phase shift has been performed in the first phase shifter and the second signal light obtained after a phase shift has been performed in the second phase shifter to obtain modulated signal light, and
the second phase shifter is constituted to have a smaller amount of phase shift according to a predetermined amount of drive voltage than the first phase shifter.
